(19) United States
(12) Patent Application Publication
(10) Pub. No.: US 2026/0045174 A1
(43) Pub. Date: Feb. 12, 2026

(54) FLIGHT SIMULATION SYSTEMS AND METHODS

(71) Applicant: Israel Aerospace Industries Ltd., Lod (IL)

(72) Inventor: Yaacov TAVGER, Kiryat Arba (IL)

(21) Appl. No.: 18/998,631

(22) PCT Filed: Aug. 9, 2023
(86) PCT No.: PCT/IL2023/050827

§ 371 Date: Jan. 27, 2025

(30) Foreign Application Priority Data
Aug. 11, 2022 (IL) 295579

(51) Int. Cl. G09B 9/12; G09B 9/10; G09B 9/20; G09B 9/30

(52) U.S. Cl. CPC G09B 9/12; G09B 9/10; G09B 9/206; G09B 9/302; G09B 9/307

(57) ABSTRACT

A flight simulation system for enabling g-force training includes a seating system, a sensor arrangement, and a controller. The seating system is configured for accommodating a human occupant and for providing thereto physically simulated flight conditions corresponding to predetermined real flight conditions, the predetermined real flight conditions including g-forces, wherein the physically simulated flight conditions include application of non-g forces to the human occupant corresponding to the g-forces, and wherein the g-forces are considered sufficient to provide g-force induced physiological stress to the human occupant. The sensor arrangement is configured for providing real-time feedback data of predetermined physiological parameters of the human occupant, in operation of the flight simulation system with the human occupant accommodated in the seating system, wherein the predetermined physiological parameters are indicative of the g-force induced physiological stress. The controller is configured for controlling the seating system to provide the physically simulated flight conditions.

### TECHNOLOGICAL FIELD

The presently disclosed subject matter relates to flight simulation systems and methods, in particular for enabling training.

### BACKGROUND

Pilots who undergo high g-forces maneuvers are subject to physiological stress that can lead to g-induced loss of consciousness (G-LOC), and/or vision problems such as loss of vision, tunnel vision and so on. High g-forces can cause blood to flow away from the brain, and can cause breathing difficulties.

The ability of the pilot to anticipate the physiological stress and to initiate anti-g straining maneuvers (AGSM) or the like can significantly increase survivability of the pilot, and training systems and methods are known that attempt to train pilots to increase improve response to g-forces.

By way of non-limiting example, DE102020205898 discloses a training device for training of a pilot of an aircraft, comprising: a display device to display a perceptible effect by the pilot signal, the effect signal a flight maneuvers induced acceleration forces caused by physical degradation of the pilot, a sensing device for sensing a muscle activity of at least one muscle of the pilot and for generating an activity signal, the activity signal represents the sensed muscle activity, and comprising a determiner for determining of the effect signal generated at least in dependency of the activity signal and a predetermined acceleration signal, wherein the predetermined acceleration signal represents the flight maneuver conditional acceleration forces.

Also by way of non-limiting example, U.S. Pat. No. 11,109,817 discloses systems and methods for measuring oxygenation signals. The method includes positioning an oxygenation measuring system over a side portion of a head of a user, wherein the oxygenation measuring system includes an outer shell, a gel seal coupled to the outer shell, a near-infrared spectroscopy sensor configured to measure oxygenation signals from a user, a printed circuit board coupled to the near-infrared spectroscopy sensor, and a bone conducting transducer. The method further includes measuring the oxygenation signals from the user using the near-infrared spectroscopy sensor, recording data pertaining to the measured oxygenation signals of the user, and comparing the data, using the printed circuit board, with known human performance data.

Also by way of non-limiting example, U.S. Pat. No. 9,799,233 discloses an apparatus for operating a simulator with a special impression of reality. The apparatus is configured for learning how to control a vehicle moving in three-dimensional reality. Controllable systems for detecting human stress reactions are provided. The controllable systems may be configured for sensing the resistance of the skin and for detecting movements of persons and physiognomy.

Also by way of non-limiting example, U.S. Pat. No. 9,576,496 discloses a system for training a subject to recognize the onset of hypoxia, the system including (i) a flight simulation system, and (ii) a hypoxia induction system, wherein the flight simulation system is operably linked to the hypoxia induction system. The system provides a tool for pilot training to a pilot, allowing for the delivery of standardized training programs where the tasks required for the operation of an aircraft are able to be coordinated with an induction of hypoxia in the subject. Such a system is also able to provide an assessment tool to demonstrate when a pilot has had sufficient training in recognizing the effects of hypoxia.

Also by way of non-limiting example, FR 2,717,289 discloses a seat held on a tubular swiveling section and pivots independently in two axes. The axes are geared, allowing movement in two right angular planes. Programmed calibrated movements can be input. The user wears a helmet with an image viewer in front. The image viewer totally masks outside points of reference. The helmet has a microphone and earphones. The seat has a manual command and vibration system. The angle of inclination of the seat can vary as a function of image speed.

### GENERAL DESCRIPTION

According to a first aspect of the presently disclosed subject matter here is provided a flight simulation system for enabling g-force training, comprising
a seating system configured for accommodating a human occupant and for providing to the human occupant physically simulated flight conditions corresponding to predetermined real flight conditions, said predetermined real flight conditions including g-forces, wherein said physically simulated flight conditions include application of non-g forces to the human occupant corresponding to said g-forces, and wherein said g-forces are considered sufficient to provide g-force induced physiological stress to the human occupant;
a sensor arrangement configured for providing real-time feedback data of predetermined physiological parameters of the human occupant, in operation of the flight simulation system with the human occupant accommodated in the seating system, wherein said predetermined physiological parameters are indicative of said g-force induced physiological stress;
a controller configured for controlling the seating system to provide said physically simulated flight conditions.

For example, said predetermined real flight conditions include real control moments in pitch, yaw and roll, and wherein said physically simulated flight conditions further include physically simulated control moments in pitch, yaw and roll applied to the human occupant corresponding to said respective real control moments in pitch, yaw and roll.

Additionally or alternatively, for example, said g-force induced physiological stress includes at least one of: breathing difficulties; blood loss in the brain; reduced vision; tunnel vision; loss of vision; loss of consciousness.

Additionally or alternatively, for example, the flight simulation system further comprises a display device coupled to the controller and to the sensor system, the display device being configured for displaying to the human occupant at least said real-time feedback data. For example, the display device is configured for comparing said real-time feedback data with first datum feedback data representative of first threshold levels of said predetermined physiological parameters, wherein said first threshold levels are considered to be representative of safe levels for said predetermined physiological parameters at least sufficient for avoiding onset of g-force induced loss of consciousness. Additionally or alternatively, for example, the display device is configured for alerting the human occupant responsive to said real-time feedback data approaching or exceeding second datum feedback data representative of second threshold levels of said predetermined physiological parameters, wherein said second threshold levels are considered to be representative of minimum unsafe levels for said predetermined physiological parameters corresponding to onset of g-force induced loss of consciousness.

For example, the display device is configured for prompting the human occupant to initiate anti-g straining maneuvers (AGSM) for managing levels of said predetermined physiological parameters at least when said second threshold level is being approached or exceeded, and for reducing said levels to said first threshold level. For example, said AGSM comprises application of muscle tension procedures to predetermined muscle groups by the human occupant. For example, said predetermined muscle groups include muscles in the abdomen and extremities of the human occupant.

Additionally or alternatively, for example, said AGSM comprises the human occupant applying rapid static contractions of muscles in at least one of the arms, legs and abdomen.

Additionally or alternatively, for example, said AGSM comprises the human occupant applying specialized breathing cycle configured to maintain air pressure in the lungs.

Additionally or alternatively, for example, said sensor arrangement includes a sensor configured for determining an electromyography (EMG) parameter of the human occupant.

Additionally or alternatively, for example, said sensor arrangement includes a sensor configured for determining a pneumograph parameter of the human occupant.

Additionally or alternatively, for example, said sensor arrangement includes a sensor configured for determining a brain blood oxygenation level parameter of the human occupant.

Additionally or alternatively, for example, said seating system comprises a mechanical force application system configured for applying said non-g forces to the human occupant corresponding to said g-forces being simulated by the system.

For example, said mechanical force application system comprises a plurality of belts configured for being peripherally wound around respective body portions of the human occupant when seated with respect to the seating system, the belts being coupled to a tensioning device, the tensioning device being configured for selectively tightening or loosening a respective abutment contact between each respective said belt and the respective body portion of the human occupant, such as to respectively increase or decrease a magnitude of said non-g forces to the respective body portion of the human occupant corresponding to predetermined g-forces being simulated by the system.

For example, said mechanical force application system comprises a plurality of inflatable members configured for being peripherally wound around respective body portions of the human occupant when seated with respect to the seating system, the inflatable members being coupled to an inflation device, the inflation device being configured for selectively inflating or deflating the respective inflatable members to respectively increase or decrease a respective abutment pressure between each respective said inflatable member and the respective body portion of the human occupant, such as to respectively increase or decrease a magnitude of said non-g forces to the respective body portion of the human occupant corresponding to predetermined g-forces being simulated by the system.

Additionally or alternatively, for example, said body portions include at least one of: the arms; the legs; the shoulders; the abdomen; the head; the chest; the neck.

Additionally or alternatively, for example, the seating system comprises a seat including a seat cushion and a backrest, the seat being coupled to a rotary motion inducing structure configured for selectively generating said simulated control moments in pitch, yaw and roll to the seat corresponding to said real control moments in pitch, yaw and roll.

For example, said rotary motion inducing structure comprises a movable frame pivotably mounted to a base structure, wherein the seat is pivotably mounted to the movable frame, such as to enable the seat to be pivoted with respect to the base structure in one, two or three degrees of freedom, and wherein said rotary motion inducing structure comprises a driving system for selectively pivoting the seat with respect to the base structure in said one, two or three degrees of freedom, to provide said control moments in pitch, yaw and roll to the seat responsive to receiving actuation command from the controller corresponding to said predetermined respective aircraft control moments being simulated by the flight simulation system.

For example, the seat is mounted in a cockpit mock-up, and wherein said rotary motion inducing structure comprises a movable frame pivotably mounted to a base structure, wherein the cockpit mock-up is pivotably mounted to the movable frame, such as to enable the seat to be pivoted with respect to the base structure in one, two or three degrees of freedom, and wherein said rotary motion inducing structure comprises a driving system for selectively pivoting the cockpit mock-up with respect to the base structure in said one, two or three degrees of freedom, to provide said control moments in pitch, yaw and roll to the cockpit mock-up responsive to receiving actuation command from the controller corresponding to said predetermined respective aircraft control moments being simulated by the flight simulation system.

Additionally or alternatively, for example, the flight simulation system comprises a visual display device configured for providing a visual display of a virtual simulation corresponding to said flight conditions from a subjective visual viewpoint of the human occupant when accommodated in said seating system. For example, the visual display device is in the form of virtual reality goggles.

Additionally or alternatively, for example, the seating system comprises a manual control actuable by the human occupant when the human occupant is accommodated in the seating system, said manual control being operatively connected to the controller, wherein the manual control is configured for enabling the human occupant to define the flight conditions being simulated by manipulating said manual control, and wherein the manual control is configured for providing control signals to the controller to thereby cause the seating system to provide a corresponding said physical flight simulation to the human occupant corresponding to said predetermined g-forces and said predetermined respective aircraft control moments responsive to manual actuation of the manual control by the human occupant. For example, said manual control is in the form of a joystick.

According to a second aspect of the presently disclosed subject matter, there is provided a method for enabling g-force training, comprising:
providing a flight simulation system as defined herein regarding the first aspect of the presently disclosed subject matter;
accommodating a human occupant in the flight simulation system;
choosing a real flight condition to be simulated by the flight simulation system;
causing the controller to provide to the human occupant a physical simulated flight condition corresponding to said real flight condition, said physical simulated flight condition including corresponding physically simulated non-g forces and optionally corresponding physically simulated respective aircraft control moments.

For example, said real flight conditions include g-forces within a range 0 to 9, and comprising the step of operating said seating system to cause application to the human occupant of said physically simulated g-forces in the form of respective non-g forces.

For example, said real flight conditions include g-forces up to 35 g, and comprising the step of operating said seating system to cause application to the human occupant of said physically simulated g-forces in the form of respective non-g forces.

Additionally or alternatively, for example, the method comprises providing real-time feedback data of said predetermined physiological parameters of the human occupant at said physically simulated flight conditions.

Additionally or alternatively, for example, the method comprises an AGSM step wherein the human occupant initiates anti-g straining maneuvers (AGSM) for managing levels of said predetermined physiological parameters responsive to application of said non-g forces to the human occupant.

For example, the AGSM step comprises the following steps:
(a) setting said real flight conditions to correspond to a minimum g-force greater than 1.0;
(b) providing real-time feedback data of predetermined physiological parameters of the human occupant at the real flight conditions of step (a);
(c) the human occupant initiates anti-g straining maneuvers (AGSM) for managing levels of said predetermined physiological parameters responsive to application of said non-g forces to the human occupant corresponding to said g-force;
(d) providing real-time feedback data of predetermined physiological parameters of the human occupant at the flight conditions of step (c);
(e) setting said real flight conditions to correspond to an increment in said g-force;
(f) repeating steps (c) and (d) at the increased g-force of step (e);
(g) checking whether the increased g-force of step (e) exceeds predetermined safety limits, wherein:
   if the increased g-force of step (e) exceeds predetermined safety limits, terminate the said flight simulation; or
   if the increased g-force of step (e) does not exceed said predetermined safety limits repeating steps (e) to (g).

For example, said minimum g-force is 1.5 g.

Additionally or alternatively, for example, said increment in said g-force is 0.5 g.

Additionally or alternatively, for example, said predetermined safety limits corresponds to a g-force of 9 g.

Additionally or alternatively, for example, said predetermined safety limits corresponds to a g-force of 35 g.

Additionally or alternatively, for example, said step of initiating said AGSM comprises the human occupant applying muscle tension procedures to predetermined muscle groups.

For example, said predetermined muscle groups include muscles in the abdomen and extremities of the human occupant.

Additionally or alternatively, for example, said step of initiating said AGSM comprises the human occupant applying rapid static contractions of muscles in the arms, legs and abdomen.

Additionally or alternatively, for example, said step of initiating said AGSM comprises the human occupant applying specialized breathing cycle configured to maintain air pressure in the lungs.

Additionally or alternatively, for example, said sensor arrangement operates to provide an electromyography (EMG) parameter of the human occupant.

Additionally or alternatively, for example, said sensor arrangement operates to provide a pneumograph parameter of the human occupant.

Additionally or alternatively, for example, said sensor arrangement operates to provide a brain blood oxygenation level parameter of the human occupant.

Additionally or alternatively, for example, said real flight conditions include any one of: evasive maneuvers, dog fight maneuvers, diving maneuvers.

A feature of at least one example of the presently disclosed subject matter is a training system and a training method are provided enabling human occupants to be physically subjected to non-g forces corresponding to real g-forces of real flight conditions, and for enabling the human occupants to experience such non-g forces in a range of real flight maneuvers.

Another feature of at least one example of the presently disclosed subject matter is a training system and method is provided enabling human occupants to be physically subjected to non-g forces corresponding to g-forces of real flight conditions, and for enabling the human occupants to train to resist the effects of such forces.

Another feature of at least one example of the presently disclosed subject matter is a training system and method is provided enabling human occupants to be physically subjected to non-g forces corresponding to g-forces of aircraft seat ejection conditions.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 schematically illustrates a flight simulation system according to an example of the presently disclosed subject matter.

FIG. 2(a) shows in side view a seat including a mechanical force application system according to a first example of the presently disclosed subject matter; FIG. 2(b) shows in front view the example of FIG. 2(a).

FIG. 3(a) shows in side view a seat including a mechanical force application system according to a second example of the presently disclosed subject matter; FIG. 3(b) shows in front view the example of FIG. 3(a).

FIG. 4 schematically illustrates an auxiliary display device comprised in the example of FIG. 1.

FIG. 5 schematically illustrates a training method according to an example of the presently disclosed subject matter.

FIG. 6 schematically illustrates sub-steps of a training step of the example of FIG. 5.

### DETAILED DESCRIPTION

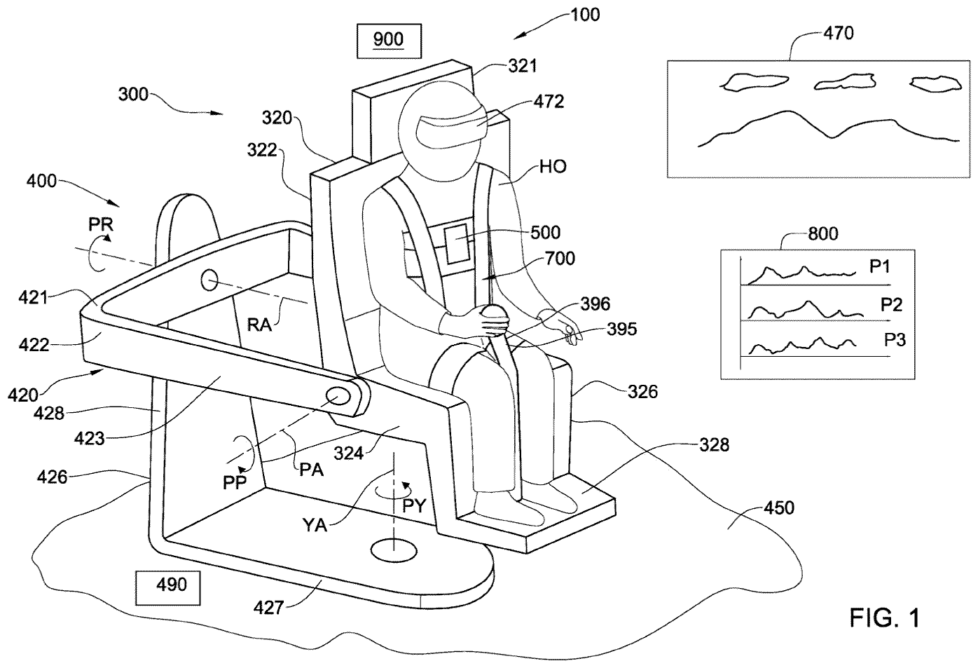

Referring to FIG. 1, a flight simulation system for enabling g-force training according to a first example of the presently disclosed subject matter, generally designated 100, comprises a seating system 300, a sensor arrangement 500, and a controller 900.

As will become clearer herein, the seating system 300 is configured for accommodating a human occupant HO and for providing to the human occupant HO physically simulated flight conditions PFC corresponding to predetermined real flight conditions RFC. For example, the human occupant HO can be a pilot, navigator, weapons specialist, passenger, and so on.

Also as will become clearer herein, the predetermined real flight conditions RFC include at least real g-forces, while the physically simulated flight conditions PFC include at least physical application of non-g forces to the human occupant HO corresponding to said g-forces. Such real g-forces are considered sufficient to provide g-force induced physiological stress to the human occupant HO.

Herein, said g-force induced physiological stress includes at least one of: breathing difficulties; blood loss in the brain; reduced vision; tunnel vision; loss of vision; g-LOC. On the other hand, herein, said g-force induced physiological stress does not include other types of physiological stress that are not a direct result of the application of g-forces to the body, and thus excludes, for example, hypoxemia (low oxygen supply in blood) or hypoxia (low oxygen supply in body tissues).

In at least this example, the predetermined real flight conditions RFC can also include real control moments in pitch RP, yaw RY and roll RR, and the physically simulated flight conditions PFC can thus further include physically simulated control moments in pitch PP, yaw PY, and roll PR applied to the human occupant HO corresponding to the respective real control moments in pitch RP, yaw RY, and roll RR.

In at least this example, the seating system 300 comprises a seat 320 including a seat cushion 322 and a backrest 324, and the seat 320 can be similar to a pilot seat used in aircraft for example, at least in terms of the size, look and/or feel experienced by the human occupant HO. In at least this example, the seat 320 also comprises a footrest 328 and a lower leg support 326 extending between the front end of the seat cushion 324 and the footrest 328. In at least this example, the seat 320 also comprises a headrest 321 vertically projecting away from the top end of the backrest 324. While not shown, the seat 320 can optionally also comprise armrests, which optionally can also be adjustable in height, for example.

In at least some examples, the relative proportions and/or angular dispositions between at least some of the seat components, including one or more of the headrest 321, backrest 322, seat cushion 324, lower leg support 326, footrest 328, armrests, are adjustable to cater for a range of human occupants HO of different sizes.

Thus, when the human occupant HO is seated in the seat 320, the head is in abutment with the headrest 321, the upper torso including the chest and midriff is in abutment with the backrest 322, the lower torso and the upper legs are in abutment with the seat cushion 324, the lower legs are in abutment with the lower leg support 326, and the feet are in abutment with the foot support 328, while the arms are in abutment with the armrests.

The seating system 300 further comprises a rotary motion inducing structure 400 coupled to the seat 320. The rotary motion inducing structure 400 is configured for selectively generating the physically simulated control moments in pitch PP, yaw PY, and roll PR to the seat 320, and thus to the human occupant HO, corresponding to the respective real control moments in pitch RP, yaw RY, and roll RR.

By “physically simulated control moments” in pitch PP, yaw PY, and roll PR is meant that physical control moments (respectively in pitch, yaw and roll) are physically generated by the rotary motion inducing structure 400 and physically applied to the human occupant HO via the seat 320, and that the human occupant HO physically experiences such physically generated control moments, independently of the human occupant HO being optionally informed (for example via a computer screen or via a human instructor) that the human occupant HO is being, or should imagine being, subjected to such control moments.

In at least this example, the rotary motion inducing structure 400 comprises a movable frame 420 and a fixed base structure 450. The movable frame includes a first frame member 422 pivotably mounted with respect to a second frame member 426 about a roll axis RA. The seat 320 is pivotably mounted to the movable frame 420, in particular to the first frame member 422, about a pitch axis PA. For example, the first frame member 422 is U-shaped, having a pair of laterally spaced arms 423 projecting from a base member 421, and the seat 320 is pivotably mounted to the free ends of the arms 423. The movable frame 420, in particular the second frame member 426, is pivotably mounted to the base structure 450 about a yaw axis YA. For example, the second frame member 426 is L-shaped, having a lower base element 427 and a vertical arm 428 vertically projecting from the base element 427. The base member 421 is pivotably mounted to the vertical arm 428 about the roll axis RA, while the base element 427 is pivotably mounted to the base structure 450 via the yaw axis YA. In this manner, the rotary motion inducing structure 400 enables the seat 320 to be pivoted with respect to the base structure 450 in one, two or three degrees of freedom, i.e., about one or more of the pitch axis PA, the roll axis RA and the yaw axis YA.

The rotary motion inducing structure 400 further comprises a driving system 490 for selectively pivoting the seat 320 with respect to the base structure 450 in the aforesaid one, two or three degrees of freedom, to provide the physically simulated control moments in pitch PP, yaw PY, and roll PR to the seat 320 responsive to receiving actuation commands from the controller 900 corresponding to the predetermined respective aircraft real control moments in pitch RP, yaw RY, and roll RR being simulated by the flight simulation system 100.

For example, the driving system 490 comprises a plurality of motors, for example electrical motors, and/or pneumatic motors, and/or hydraulic motors, for selectively pivoting the seat 320 with respect to the first frame member 422 about the pitch axis PA, for selectively pivoting the first frame member 422 with respect to the second frame member 426 about the roll axis RA, and for selectively pivoting the second frame member 426 with respect to the base structure about the pitch axis PY.

The controller 900 is operatively coupled to the driving system 490, for example via cables or wirelessly, enabling the driving system 490 to apply physically simulated control moments in one or more of pitch PP, yaw PY, and roll PR to the seat 320.

In at least this example, the seating system 300 further comprises a visual display 470, for example a panoramic display, configured for providing a visual display of a virtual simulation corresponding to the real flight conditions RFC from a subjective visual viewpoint of the human occupant HO when accommodated in seating system 300.

The display 470 is operatively coupled to the controller 900.

For example, the display 470 provides a computer generated real-time forward view (with respect to the human occupant HO) of the outside environment corresponding to and consistent with the real flight conditions RFC, and the viewing angle of the outside environment and speed of movement of fixed items (for example the ground or horizon) in the display change consistent with the real g-forces and real control moments in pitch RP, yaw RY, and roll RR being simulated by the flight simulation system 100.

In at least this example, the display 470 is in the form of virtual reality goggles 472, for example including any one of VR goggles, AR goggles, or XR goggles, which are worn by the human occupant HO.

However, in alternative variations of this example, the display 470 can be non-connected physically to the human occupant HO, for example in the form of one or more screens (for example LED or OLED screens) spaced from the seated human occupant HO, and which partially of fully surround the seating system 300, for example in the form of a canopy or faceted wall around the seating system 300.

In at least this example, the seating system 300 further comprises a manual control 396 actuable by the human occupant HO when the human occupant HO is accommodated in the seating system 300. Such a manual control 396 is operatively connected to the controller 900. The manual control 396 is configured for enabling the human occupant HO to define the flight conditions being simulated by the flight simulation system 100, by manipulating the manual control 396, for example in a similar manner to a real aircraft. The manual control 396 is configured for providing control signals to the controller 900 to thereby cause the seating system 300 to provide a corresponding physical flight simulation to the human occupant HO corresponding to the predetermined g-forces and to the respective aircraft control moments responsive to manual manipulation of the manual control 396 by the human occupant HO.

In at least this example, the manual control 396 is in the form of a joystick 395, for example similar to the joystick of a real aircraft. For example, the joystick can be located in-between the legs of the human occupant HO, as illustrated in FIG. 1 for example, or on one side of the human occupant HO, for example coupled to one of the armrests or to another part of the seat or cockpit mock-up. In alternative variations of this example, the joystick can be replaced with any suitable yoke that can be configured to appear, feel and operate in a similar manner to that of an aircraft that is being simulated.

Thus, the joystick 395, operatively connected to the controller 900, operates to relay to the controller 900 control inputs from the human occupant HO regarding the real flight conditions RFC that the human occupant HO wishes to have simulated by the flight simulation system 100.

Thus, the human occupant HO can manipulate the joystick 395 to virtually execute any desired flight maneuver in terms of acceleration, deceleration, climb, dive, turning in pitch, roll and/or yaw, and so on. The controller 900 receives the aforesaid control inputs from the joystick 395 and in turn sends control outputs to the seating system 300 to provide physical simulation to the human occupant HO corresponding to these flight conditions, and concurrently, the panoramic display 470 provides a corresponding virtual visual display of the external environment consistent with such flight maneuvers.

For example, the operation of the joystick 395 can be of use in the training of a human occupant HO having the role of a pilot.

However, in alternative variations of at least this example, the joystick 395 can be omitted or disconnected or not used, and the physically simulated flight conditions PFC are provided in a different manner. For example, a number of different sets of control outputs corresponding to a number of different physically simulated flight conditions PFC are included in a memory of the controller 900, and the controller 900 can be preset, or activated externally, to implement one or more such physically simulated flight conditions PFC by transmitting the respective outputs as provided by the memory. Additionally or alternatively, an external human controller can control operation of the controller 900 by inputting in real time control inputs corresponding to desired physically simulated flight conditions PFC, for example by using an external joystick operatively coupled to the controller 900. For example, such an external joystick can be operated by a human operator that is not accommodated in the seating system 300. In such cases, the human occupant HO of the seating system 300 can have a non-pilot role, for example navigator, passenger, weapons specialist, and so on.

It is to be noted that in at least some alternative variations of this example, the seat 320 of the seating system can instead be incorporated in a cockpit mock-up or the like, and the rotary motion inducing structure is coupled to the cockpit mock-up. In such cases the display can be coupled to the cockpit window(s), for example.

As mentioned above, while the predetermined real flight conditions RFC include at least real g-forces, the physically simulated flight conditions PFC include at least application of non-g forces to the human occupant HO corresponding to said g-forces.

By “non-g forces” is meant mechanical forces that are not gravitational or centrifugal in origin, and thus exclude mechanical forces that can be generated on a human subject using a centrifuge or the like.

Thus, such non-g forces include mechanical forces that can be applied, for example to the human occupant HO when accommodated in the seating system 300, via physical contact in a load-bearing manner between the respective force applicator and the human occupant HO.

In at least this example, the seating system 300 comprises a respective force applicator in the form of a mechanical force application system 700 configured for applying the aforesaid non-g forces to the human occupant HO corresponding to the real g-forces being simulated by the flight simulation system 100.

In particular, mechanical force application system 700 is configured for applying the aforesaid non-g forces to desired body portions of the human occupant HO. For example, such body portions can include at least one of: the arms; the legs; the shoulders; the abdomen; the head; the chest; the neck.

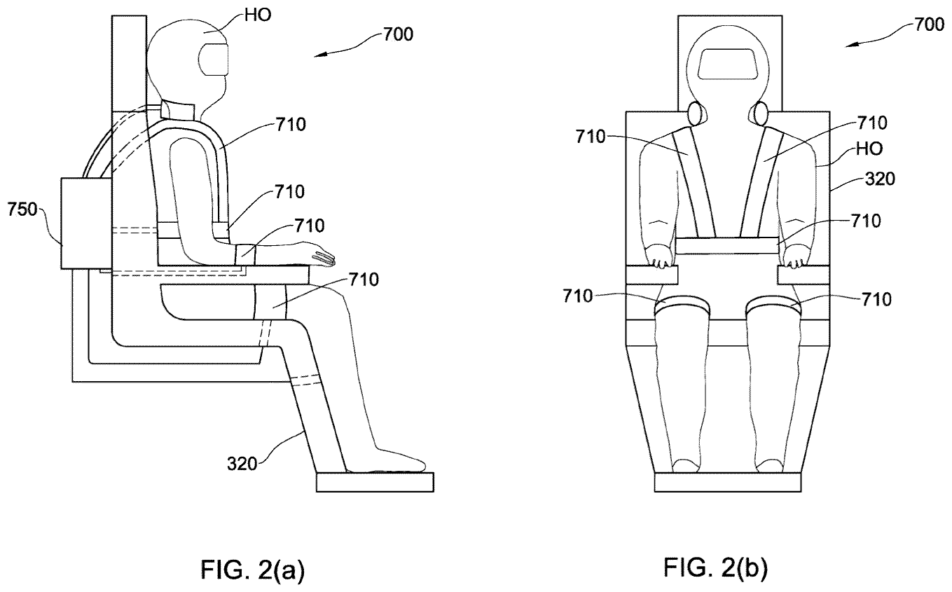

Referring to FIG. 2(a) and FIG. 2(b), a first example of the mechanical force application system 700 comprises a harness including a plurality of belts 710 and a tensioning device 750.

It is to be noted that the belts 710 are different from the regular seatbelts (not shown) that can optionally be used with the seating system 300. Such seatbelts are typically used in the real aircraft for securing the human occupant to the seat.

The belts 710 are configured for being peripherally wound around respective body portions of the human occupant HO when seated with respect to the seating system 300. The belts 710 are coupled to the tensioning device 750, and the tensioning device is operatively coupled to the controller 900.

The tensioning device 750 is configured for selectively tightening or loosening a respective abutment contact between each respective belt 710 and the respective body portion of the human occupant, responsive to receiving appropriate command signals from the controller 900, such as to respectively increase or decrease a magnitude of said non-g forces applied via the belts 710 to the respective body portion of the human occupant HO corresponding to predetermined g-forces being simulated by the mechanical force application system 700.

For example, the tensioning device 750 comprises a plurality of motors, each motor being configured for turning a pulley or the like on which an end of a respective belt 710 is wound. The other end of each belt is anchored to a suitable location on the seat 320. As the particular motor is selectively turned clockwise or counterclockwise, the belt is further wound or unwound, respectively, with respect to the pulley, thereby tightening or untightening with respect to the respective body part of the human occupant HO. In this manner, the human occupant HO can be made to experience non-g mechanical forces on different parts of the body, consistent with the type of maneuver and g-forces being simulated by the flight simulation system 100 in real time.

For example, the belts 710 can include one or more of the following:
shoulder belts provided over the shoulders;
chest belts provided over the chest and lungs;
abdominal belts provided over the abdomen;
arm belts provided over the arms, for example the forearms;
leg belts provided over the legs, for example the lower legs and/or the upper legs.

Special arrangements can be provided for the neck area such as to provide a mechanical force to the neck area while not strangulating the human occupant HO. For example, a U-shaped neck brace can be provided having a pressure-application component configured for selectively applying pressure to the carotid arteries to thereby diminish blood flow to the grain, as controlled by controller 900.

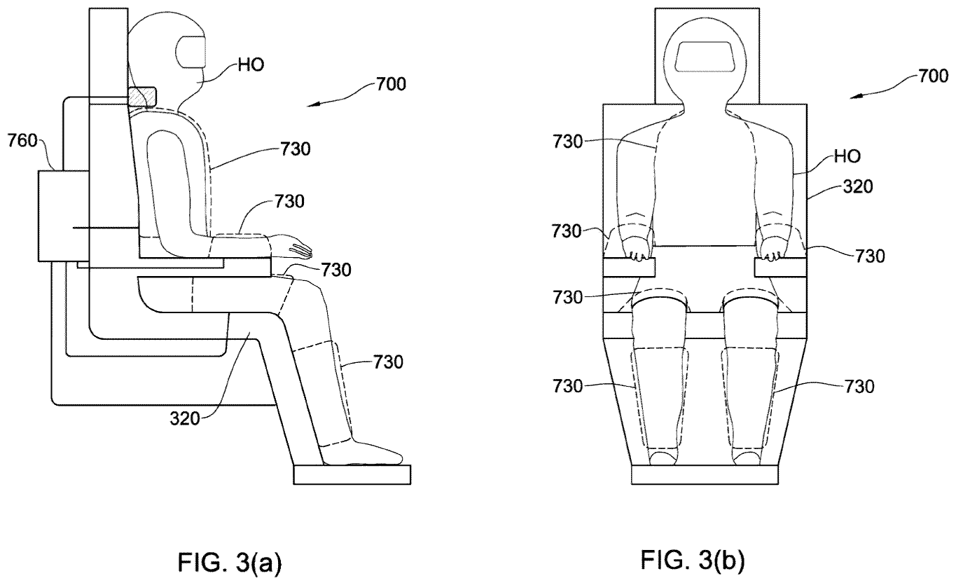

Referring to FIG. 3(a) and FIG. 3(b), a second example of the mechanical force application system 700 comprises a plurality of inflatable members 730 coupled to an inflation device 760. While in this example the inflatable members 730 can be inflated pneumatically by the inflation device 760, in alternative variations of this example, the inflation device is configured for hydraulically inflating the inflatable members.

The inflatable members 730 are configured for being peripherally wound around respective body portions of the human occupant HO when seated with respect to the seating system 300. For example each inflatable member 730 is in the form of a sleeve that includes a lumen which accommodates the respective body part. The inflatable members 730 are each coupled to the inflation device 760, which is in turn operatively coupled to the controller 900. The inflation device 760 is configured for selectively inflating or deflating the respective inflatable members 730 individually to respectively increase or decrease a respective abutment pressure between each respective inflatable member 730 and the respective body portion of the human occupant HO. In this manner, it is possible to respectively increase or decrease a magnitude of the respective non-g forces applied by the inflatable members 730 to the respective body portion of the human occupant HO corresponding to predetermined g-forces being simulated by the system 100.

For example, inflatable members 730 can include one or more of the following:
inflatable members provided over the shoulders;
inflatable members provided over the chest and lungs;
inflatable members provided over the abdomen;
inflatable members provided over the arms, for example the forearms;
inflatable members provided over the legs, for example the lower legs and/or the upper legs.

Also in this example, special arrangements can be provided for the neck area such as to provide a mechanical force to the neck area while not strangulating the human occupant HO. For example, a U-shaped neck brace can be provided having a pressure-application component configured for selectively applying pressure to the carotid arteries to thereby diminish blood flow to the grain, as controlled by controller 900.

Referring again to FIG. 1, the sensor arrangement 500 is configured for providing real-time feedback data of predetermined physiological parameters PPP of the human occupant HO, in operation of the flight simulation system 100 with the human occupant HO accommodated in the seating system 300, wherein the predetermined physiological parameters PPP are indicative of the aforesaid g-force induced physiological stress.

In at least some examples, the sensor arrangement 500 includes one or more of the following:
an EMG sensor 510 configured for determining an electromyography (EMG) parameter P1 of the human occupant HO;
a pneumograph sensor 520 configured for determining a pneumograph parameter P2 of the human occupant HO;
a brain blood oxygenation level sensor 530 configured for determining a brain blood oxygenation level parameter P3 of the human occupant HO.

For example, such EMG sensors 510 can be provided on the muscles for example of the arms and/or legs of the human occupant, and for example the results for each such sensor can be recorded separately.

For example, such pneumograph sensor 520 can be coupled to the lungs of the human occupant, for example via a breathing mask.

For example, such brain blood oxygenation level sensor 530 can be in for example the form of a blood saturation non-invasive sensor, and for example coupled to suitable blood vessels, for example on parts of the head or neck of the human occupant.

For example, the EMG parameter P1 can be in the form of a variation of measured microvolts (μV) with time.

For example, the pneumograph parameter P2 can be in the form of a variation of volume flow (for example liters/sec) with time, or volume (for example liters) with time.

For example, the brain blood oxygenation level parameter P3 can be in the form of a variation of micro Moles (μMol) of hemoglobin with time, in particular micro Moles (μMol) of oxygenated hemoglobin with time.

Referring again to FIG. 1, in at least this example, the flight simulation system 100 optionally further comprises an auxiliary display device 800 coupled to the controller 900 and to the sensor system 500. The auxiliary display device 800 is configured for displaying to the human occupant HO at least the aforesaid real-time feedback data of one or more of the aforesaid predetermined physiological parameters PPP, in particular regarding one or more of the EMG parameter P1, the pneumograph parameter P2, and the brain blood oxygenation level parameter P3 of the human occupant HO.

The auxiliary display device 800 can also be configured for concurrently showing the variation of simulated g-forces with time.

It is to be noted that in some examples the auxiliary display device 800 and the visual display device 470 can be separate components. For example, in examples in which the visual display device 470 is not physically connected to the human occupant, for example where the respective seating system 300 is accommodated in a cockpit mock-up or the like, wherein the visual display device 470 is provided on the cockpit windows or outside thereof, the auxiliary display device 800 can be accommodated within the cockpit mock up, within view of the human occupant HO, for example as part of the instrument panel.

However, in other examples the auxiliary display device 800 can be integrated with the visual display device 470, for example, the functions of the auxiliary display device 800 and the visual display device 470 can be provided in a single integrated display. For example, in examples in which the visual display device 470 is directly connected to the human occupant HO, for example in the form of virtual reality goggles 472, the auxiliary display device 800 can be in the form of a virtual auxiliary display device or in the form of a virtual auxiliary display, which can be selectively introduced in the field of view of the human occupant HO via the goggles.

Optionally, a second auxiliary display device can be provided for an external user, for example a test supervisor, to enable the external user to monitor at least the aforesaid real-time feedback data of the aforesaid predetermined physiological parameters.

As will become clearer herein, the auxiliary display device 800 provides a visual indication of how the one or more physiological parameters PPP are varying in real time during a particular simulated flight maneuver, and can further provide an indication as to how effectively the human occupant HO may be countering the physiological effects, if any. For example, during a training session using the flight simulation system 100, a number of anti-g straining maneuvers (AGSM) can be applied by the human occupant HO, and the auxiliary display device 800 can function to provide an indication as to how the AGSM are affecting the physiological parameters PPP. This can enable the human occupant HO to determine in real time how effective the applied AGSM are, and to aid the human occupant HO in further improving the implementation of the AGSM to provide even more effective response to the physiological effects to the non-g forces in physically simulated flight conditions PFC that closely resemble the real flight conditions RFC.

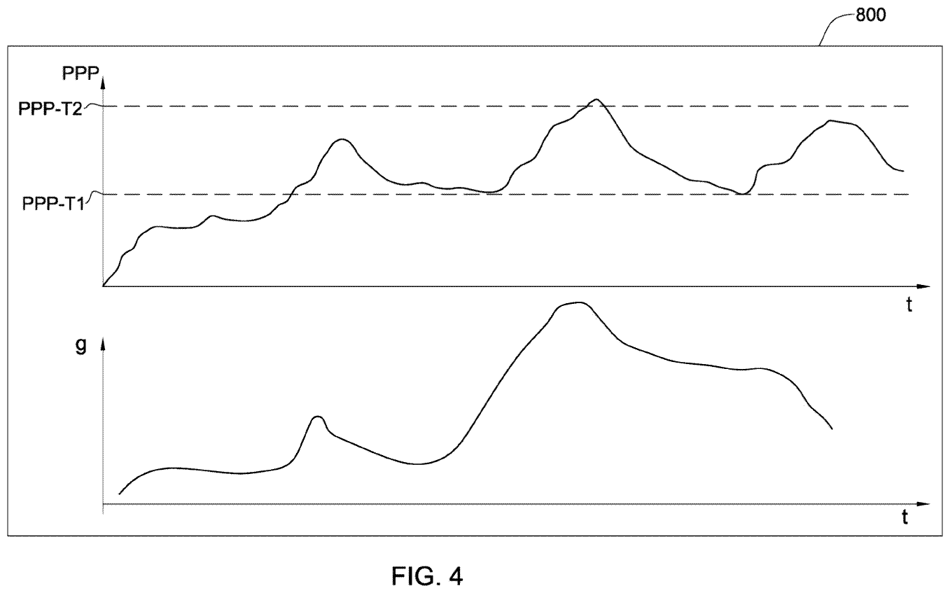

As an aid to the human occupant HO, especially for the flight training thereof, and referring to FIG. 4, the auxiliary display device 800 is configured for comparing the real-time feedback data of the physiological parameters PPP with first datum feedback data representative of respective first threshold levels PPP-T1 of the predetermined physiological parameters PPP.

The first threshold levels PPP-T1 are considered to be representative of safe levels for the predetermined physiological parameters PPP, at least sufficient for avoiding onset of g-force induced loss of consciousness.

Thus, during for example a training session for the human occupant, so long as the various predetermined physiological parameters PPP remain within the respective first threshold levels PPP-T1, there is no need for the human occupant HO to take any action to counter the physiological effects relating to the predetermined physiological parameters PPP.

For example, the first threshold levels PPP-T1 can correspond to conditions consistent with the application of g-forces in the range 1 g to 1.5 g to a human body.

As a further aid to the human occupant HO, especially for the flight training thereof, the auxiliary display device 800 can also be configured for alerting the human occupant HO responsive to the real-time feedback data of the predetermined physiological parameters PPP approaching or exceeding a second datum feedback data representative of respective second threshold levels PPP-T2 of the predetermined physiological parameters PPP. Such an alert can take the form of, for example, warning lights and/or warning messages being displayed by the auxiliary display device 800, and/or, audio warning signals.

The second threshold levels PPP-T2 are considered to be representative of minimum unsafe levels for the predetermined physiological parameters PPP corresponding to onset of g-force induced loss of consciousness (g-loc).

As a further aid to the human occupant HO, especially for the flight training thereof, the auxiliary display device 800 is configured for optionally prompting the human occupant HO to initiate anti-g straining maneuvers (AGSM) for managing levels of the predetermined physiological parameters PPP at least when the second threshold level PPP-T2 is being approached or exceeded, and for reducing said levels of the predetermined physiological parameters PPP to said first threshold level PPP-TS1.

For example, the AGSM can comprise application of muscle tension procedures to predetermined muscle groups by the human occupant. Such muscle can include, for example, muscles in the abdomen and extremities of the human occupant HO.

For example, one type of AGSM can be in the form of the human occupant HO applying rapid static contractions of muscles in at least one of the arms, legs and abdomen. Furthermore, for example, another type of AGSM can be in the form of the human occupant HO applying specialized breathing cycle configured to maintain air pressure in the lungs.

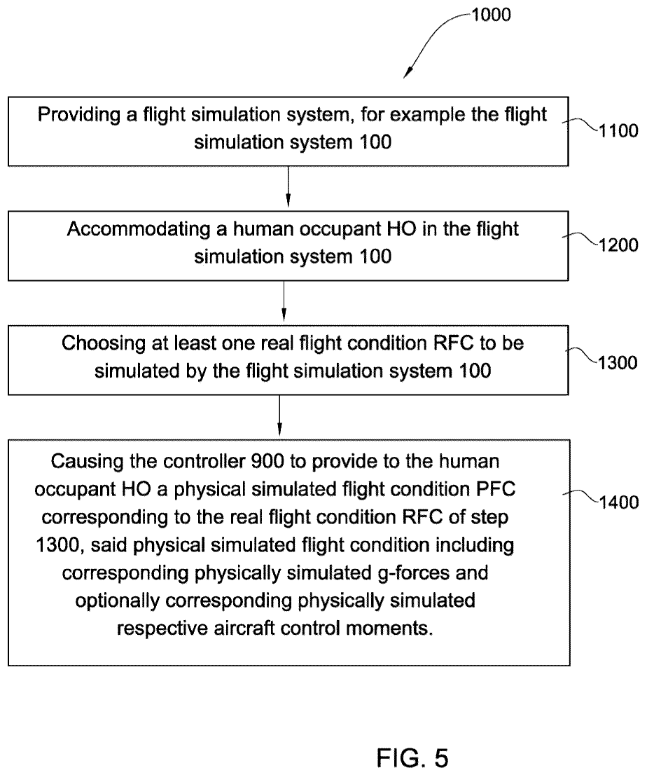

The flight simulation system 100 can be operated, for example for training a human occupant HO to become accustomed to and/or to apply for example AGSM to counter g-force induced physiological stress to the human occupant HO, for example according to at least a first example of a training method, generally designated with reference numeral 1000. Referring to FIG. 5, the training method 1000 comprises the following steps:
Step 1100˜providing a flight simulation system, for example the flight simulation system 100 as disclosed herein.
Step 1200˜accommodating a human occupant HO in the flight simulation system 100, in particular in the seating system 300 thereof.
Step 1300˜choosing at least one real flight condition RFC to be simulated by the flight simulation system 100.
Step 1400˜causing the controller 900 to provide to the human occupant HO a physical simulated flight condition PFC corresponding to the real flight condition RFC of step 1300, said physical simulated flight condition PFC including corresponding physically simulated non-g forces and optionally corresponding physically simulated respective aircraft control moments.

Thus, with the human occupant HO accommodated in the seating system 300, the flight simulation system 100 is operated to provide a physical simulation of any desired real flight conditions, either by manipulation of the joystick 395 by the human occupant HO, or by implementing simulated flight conditions from the memory of the controller 900, or by controlling operation of the controller by an external user, for example.

Such real flight conditions RFC can include, for example, any type of real flight maneuvers that are likely to be encountered by the human occupant HO when flying or when being flown in a real aircraft, and in particular wherein the real flight conditions of such maneuvers include g-forces that are considered to be sufficient to provide g-force induced physiological stress to the human occupant HO. For example, such real flight conditions RFC can include evasive maneuvers, dog fight maneuvers, diving maneuvers, climbing maneuvers, and so on. The flight simulation system 100 can provide to the human occupant HO the physical application of non-g forces generated by the seating system 300 (corresponding to the real g-forces that are being stimulated by the flight simulation system 100), to enable the human occupant HO to physically experience mechanical forces on the body in a similar manner to what the human occupant HO would experience in such real-life flight conditions.

In the first place, such a use of the flight simulation system 100 can be used for preparing the human occupant HO as to what to physically expect when flying or being flown in a real aircraft, wherein g-forces can change rapidly, and can be coupled with changes in orientation such as via roll, pitch and/or yaw.

For example, the real flight conditions RFC of step 1300 can include g-forces within a range 0 to 9 g, and step 1400 comprises the step of operating the seating system 300 to cause application to the human occupant HO of physically simulated non-g forces via the mechanical force application system 700, corresponding to the g-forces corresponding to the real flight condition RFC of step 1300.

Furthermore, and in the second place, the flight simulation system 100 can also be used for physically simulating to the human occupant HO other flight scenarios, such as for example ejection seat operation, in which the seated human occupant HO is expected to experience very high g-forces, typically in tens of g's—for example about 35 g—but only for a very short duration, in the order of milliseconds. The human occupant HO can be subjected, via the flight simulation system 100, to non-g forces corresponding to such high g-loads, and for a comparable short duration.

Furthermore, the method 1000 for using the flight simulation system 100 can further comprise providing real-time feedback data of said predetermined physiological parameters PPP of the human occupant HO at the physically simulated flight conditions PFC, for example via the auxiliary display device 800.

Thus, as a particular real flight condition RFC including g maneuvers is being simulated by the flight simulation system 100, and the seating system 300 is applying to the human occupant HO corresponding non-g forces to various body portions of the human occupant HO, the auxiliary display device 800 can display in real time the corresponding levels of the predetermined physiological parameters PPP—in particular of the EMG parameter P1, and/or of the pneumograph parameter P2, and/or of the brain blood oxygenation level parameter P3.

These levels can be monitored against the respective first threshold level PPP-T1 and the respective second threshold level PPP-T2, which can also be concurrently displayed by the auxiliary display device 800.

The method 1000 can then be expanded to enable the human occupant HO to train as to how to resist the physiological effects of high g-forces, and includes the step 1500 wherein the human occupant HO initiates anti-g straining maneuvers (AGSM) for training to manage levels of the predetermined physiological parameters PPP, responsive to application of non-g forces to the human occupant HO.

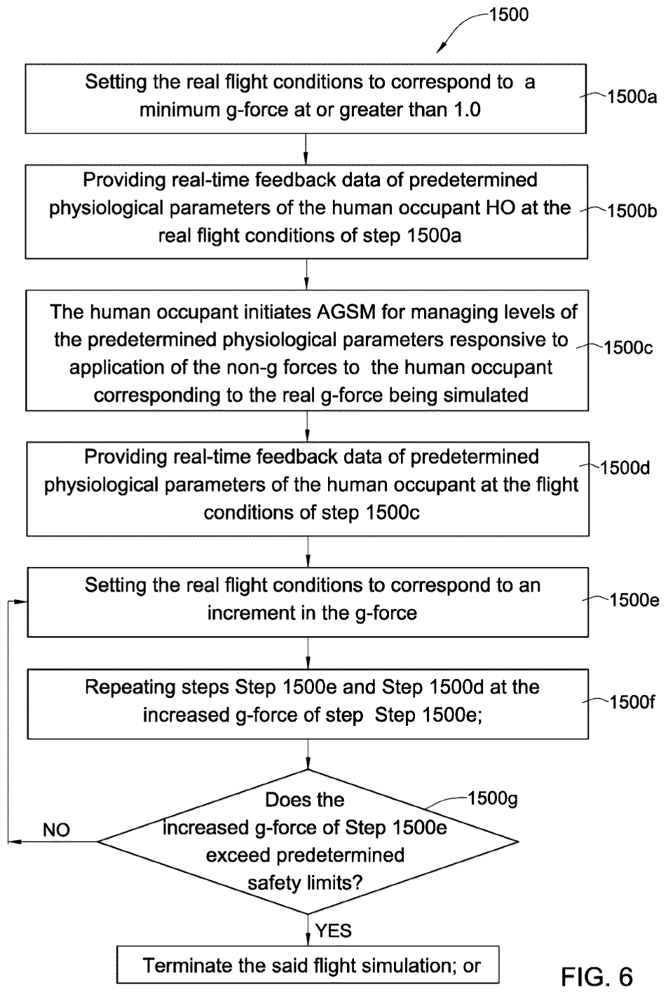

Referring to FIG. 6, training step 1500 can include the following sub-steps:
Step 1500a˜setting the real flight conditions RFC to correspond to a minimum g-force at or greater than 1 g;
Step 1500b˜providing real-time feedback data of predetermined physiological parameters PPP of the human occupant HO at the real flight conditions RFC of step 1500a;
Step 1500c˜the human occupant HO initiates anti-g straining maneuvers (AGSM) for managing levels of the one or more predetermined physiological parameters PPP responsive to application of the corresponding non-g forces to the human occupant HO (via the seating system 300) corresponding to the real g-forces being simulated;
Step 1500d˜providing real-time feedback data of predetermined physiological parameters PPP of the human occupant HO at the flight conditions of step 1500c;
Step 1500e˜setting the real flight conditions to correspond to an increment in the g-force, for example by manipulation of the joystick 395 by the human occupant HO, or by implementing simulated flight conditions from the memory of the controller 900, or by controlling operation of the controller by an external user;
Step 1500f˜repeating steps Step 1500e and Step 1500d at the increased g-force of step 1500e;
Step 1500g˜checking whether the increased g-force of step 1500e exceeds predetermined safety limits, wherein:
   if the increased g-force of Step 1500e exceeds predetermined safety limits for example corresponding to the second threshold PPP-T2, terminate the said flight simulation; or
   if the increased g-force of Step 1500e does not exceed said predetermined safety limits, then repeating Step 1500e to Step 1500g.

For example, the minimum g-force in sub-step 1500a can be 1 g or 1.5 g, and the increment in the g-force in step 1500e can be is 0.5 g, for example.

For example, the predetermined safety limits in step 1500g can correspond to a g-force of 9 g in cases where flight maneuvers per se are being simulated, while in simulation of ejection seat scenarios the predetermined safety limits in step 1500g can correspond to a g-force of 35 g.

In step 1500c, the AGSM can include the human occupant HO applying muscle tension procedures to predetermined muscle groups, for example muscles in the abdomen and extremities of the human occupant HO. Furthermore, the step of initiating the AGSM includes the human occupant HO applying rapid static contractions of muscles in the arms, legs and abdomen, for example.

As the human occupant HO is progressing with such muscle tension procedures, thereby resisting or attempting to resist the applied non-g forces, the human occupant HO can observe via the auxiliary display device 800 the effects of the muscle tension procedures in real time, for example by way of how the levels of the predetermined physiological parameters PPP are changing. Thus, the human occupant HO obtains immediate feedback of how effective the muscle tension procedures are in each of the flight conditions being simulated by the flight simulation system 100, and enables the human occupant HO to further improve resistance to the applied non-g forces.

In step 1500c, the AGSM can additionally or alternatively include the human occupant HO applying specialized breathing cycle configured to maintain air pressure in the lungs. For example, such specialized breathing cycles are well known in the art.

As the human occupant HO is progressing with such specialized breathing cycles, thereby resisting or attempting to resist the applied non-g forces, the human occupant HO can observe on the auxiliary display device 800 the effects of the specialized breathing cycles in real time, by way of how the levels of the predetermined physiological parameters PPP are changing. Thus, the human occupant HO obtains immediate feedback of how effective the specialized breathing cycles are in each of the flight conditions being simulated by the flight simulation system 100, and enables the human occupant HO to further improve resistance to the applied non-g forces.

Thus, in execution of step 1500, the sensor arrangement 500 operates to provide levels of the EMG parameter P1 of the human occupant, and/or of the pneumograph parameter P2 of the human occupant, and/or of the brain blood oxygenation level parameter P3 of the human occupant.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1-44. (canceled)

45. A flight simulation system for enabling g-force training, comprising
a seating system configured for accommodating a human occupant and for providing to the human occupant physically simulated flight conditions corresponding to predetermined real flight conditions, said predetermined real flight conditions including g-forces, wherein said physically simulated flight conditions include application of non-g forces to the human occupant corresponding to said g-forces, and wherein said g-forces are considered sufficient to provide g-force induced physiological stress to the human occupant;
a sensor arrangement configured for providing real-time feedback data of predetermined physiological parameters of the human occupant, in operation of the flight simulation system with the human occupant accommodated in the seating system, wherein said predetermined physiological parameters are indicative of said g-force induced physiological stress; and
a controller configured for controlling the seating system to provide said physically simulated flight conditions.

46. The flight simulation system according to claim 45, wherein said predetermined real flight conditions include real control moments in pitch, yaw and roll, and wherein said physically simulated flight conditions further include physically simulated control moments in pitch, yaw and roll applied to the human occupant corresponding to said respective real control moments in pitch, yaw and roll.

47. The flight simulation system according to claim 45, wherein said g-force induced physiological stress includes at least one of: breathing difficulties; blood loss in the brain; reduced vision; tunnel vision; loss of vision; g-LOC.

48. The flight simulation system according to claim 45, including one of:
wherein the flight simulation system further comprises a display device coupled to the controller and to the sensor system, the display device being configured for displaying to the human occupant at least said real-time feedback data; or
wherein the flight simulation system further comprises a display device coupled to the controller and to the sensor system, the display device being configured for displaying to the human occupant at least said real-time feedback data, and, wherein the display device is configured for comparing said real-time feedback data with first datum feedback data representative of first threshold levels of said predetermined physiological parameters, wherein said first threshold levels are considered to be representative of safe levels for said predetermined physiological parameters at least sufficient for avoiding onset of g-force induced loss of consciousness.

49. The flight simulation system according to claim 48, wherein the display device is configured for alerting the human occupant responsive to said real-time feedback data approaching or exceeding second datum feedback data representative of second threshold levels of said predetermined physiological parameters, wherein said second threshold levels are considered to be representative of minimum unsafe levels for said predetermined physiological parameters corresponding to onset of g-force induced loss of consciousness.

50. The flight simulation system according to claim 49, including one of the following:
wherein the display device is configured for prompting the human occupant to initiate anti-g straining maneuvers (AGSM) for managing levels of said predetermined physiological parameters at least when said second threshold level is being approached or exceeded, and for reducing said levels to said first threshold level;
wherein the display device is configured for prompting the human occupant to initiate anti-g straining maneuvers (AGSM) for managing levels of said predetermined physiological parameters at least when said second threshold level is being approached or exceeded, and for reducing said levels to said first threshold level, and, wherein said AGSM comprises application of muscle tension procedures to predetermined muscle groups by the human occupant; or
wherein the display device is configured for prompting the human occupant to initiate anti-g straining maneuvers (AGSM) for managing levels of said predetermined physiological parameters at least when said second threshold level is being approached or exceeded, and for reducing said levels to said first threshold level, and, wherein said AGSM comprises application of muscle tension procedures to predetermined muscle groups by the human occupant, and, wherein said predetermined muscle groups include muscles in the abdomen and extremities of the human occupant.

51. The flight simulation system according to claim 49, wherein said AGSM comprises the human occupant applying rapid static contractions of muscles in at least one of the arms, legs and abdomen.

52. The flight simulation system according to claim 49, wherein said AGSM comprises the human occupant applying specialized breathing cycle configured to maintain air pressure in the lungs.

53. The flight simulation system according to claim 45, wherein said sensor arrangement includes at least one of: a sensor configured for determining an electromyography (EMG) parameter of the human occupant; includes a sensor configured for determining a pneumograph parameter of the human occupant; a sensor configured for determining a brain blood oxygenation level parameter of the human occupant.

54. The flight simulation system according to claim 45, wherein said seating system comprises a mechanical force application system configured for applying said non-g forces to the human occupant corresponding to said g-forces being simulated by the system.

55. The flight simulation system according to claim 54, wherein said mechanical force application system comprises a plurality of belts configured for being peripherally wound around respective body portions of the human occupant when seated with respect to the seating system, the belts being coupled to a tensioning device, the tensioning device being configured for selectively tightening or loosening a respective abutment contact between each respective said belt and the respective body portion of the human occupant, such as to respectively increase or decrease a magnitude of said non-g forces to the respective body portion of the human occupant corresponding to predetermined g-forces being simulated by the system.

56. The flight simulation system according to claim 54, wherein said mechanical force application system comprises a plurality of inflatable members configured for being peripherally wound around respective body portions of the human occupant when seated with respect to the seating system, the inflatable members being coupled to an inflation device, the inflation device being configured for selectively inflating or deflating the respective inflatable members to respectively increase or decrease a respective abutment pressure between each respective said inflatable member and the respective body portion of the human occupant, such as to respectively increase or decrease a magnitude of said non-g forces to the respective body portion of the human occupant corresponding to predetermined g-forces being simulated by the system.

57. The flight simulation system according to claim 54, wherein said body portions include at least one of: the arms; the legs; the shoulders; the abdomen; the head; the chest; the neck.

58. The flight simulation system according to claim 45, including one of:
wherein the seating system comprises a seat including a seat cushion and a backrest, the seat being coupled to a rotary motion inducing structure configured for selectively generating said simulated control moments in pitch, yaw and roll to the seat corresponding to said real control moments in pitch, yaw and roll;
wherein the seating system comprises a seat including a seat cushion and a backrest, the seat being coupled to a rotary motion inducing structure configured for selectively generating said simulated control moments in pitch, yaw and roll to the seat corresponding to said real control moments in pitch, yaw and roll, and, wherein said rotary motion inducing structure comprises a movable frame pivotably mounted to a base structure, wherein the seat is pivotably mounted to the movable frame, such as to enable the seat to be pivoted with respect to the base structure in one, two or three degrees of freedom, and wherein said rotary motion inducing structure comprises a driving system for selectively pivoting the seat with respect to the base structure in said one, two or three degrees of freedom, to provide said control moments in pitch, yaw and roll to the seat responsive to receiving actuation command from the controller corresponding to said predetermined respective aircraft control moments being simulated by the flight simulation system; or
wherein the seating system comprises a seat including a seat cushion and a backrest, the seat being coupled to a rotary motion inducing structure configured for selectively generating said simulated control moments in pitch, yaw and roll to the seat corresponding to said real control moments in pitch, yaw and roll, and, wherein the seat is mounted in a cockpit mock-up, and wherein said rotary motion inducing structure comprises a movable frame pivotably mounted to a base structure, wherein the cockpit mock-up is pivotably mounted to the movable frame, such as to enable the seat to be pivoted with respect to the base structure in one, two or three degrees of freedom, and wherein said rotary motion inducing structure comprises a driving system for selectively pivoting the cockpit mock-up with respect to the base structure in said one, two or three degrees of freedom, to provide said control moments in pitch, yaw and roll to the cockpit mock-up responsive to receiving actuation command from the controller corresponding to said predetermined respective aircraft control moments being simulated by the flight simulation system.

59. The flight simulation system according to claim 45, including one of the following:
the flight simulation system comprising a visual display device configured for providing a visual display of a virtual simulation corresponding to said flight conditions from a subjective visual viewpoint of the human occupant when accommodated in said seating system;
the flight simulation system comprising a visual display device configured for providing a visual display of a virtual simulation corresponding to said flight conditions from a subjective visual viewpoint of the human occupant when accommodated in said seating system, and wherein the visual display device is in the form of virtual reality goggles;
wherein the seating system comprises a manual control actuable by the human occupant when the human occupant is accommodated in the seating system, said manual control being operatively connected to the controller, wherein the manual control is configured for enabling the human occupant to define the flight conditions being simulated by manipulating said manual control, and wherein the manual control is configured for providing control signals to the controller to thereby cause the seating system to provide a corresponding said physical flight simulation to the human occupant corresponding to said predetermined g-forces and said predetermined respective aircraft control moments responsive to manual actuation of the manual control by the human occupant; or
wherein the seating system comprises a manual control actuable by the human occupant when the human occupant is accommodated in the seating system, said manual control being operatively connected to the controller, wherein the manual control is configured for enabling the human occupant to define the flight conditions being simulated by manipulating said manual control, and wherein the manual control is configured for providing control signals to the controller to thereby cause the seating system to provide a corresponding said physical flight simulation to the human occupant corresponding to said predetermined g-forces and said predetermined respective aircraft control moments responsive to manual actuation of the manual control by the human occupant, and, wherein said manual control is in the form of a joystick.

60. The flight simulation system according to claim 45, wherein said g-force induced physiological stress includes at least one of: reduced vision; tunnel vision; loss of vision.

61. A method for enabling g-force training, the method comprising:
providing a flight simulation system as defined in claim 45;
accommodating a human occupant in the flight simulation system;
choosing a real flight condition to be simulated by the flight simulation system;
causing the controller to provide to the human occupant a physical simulated flight condition corresponding to said real flight condition, said physical simulated flight condition including corresponding physically simulated non-g forces.

62. The method according to claim 61, including at least one of the following:
wherein said physical simulated flight condition further includes corresponding physically simulated respective aircraft control moments;
wherein said real flight conditions include g-forces within a range 0 to 9 g, or up to 35 g, and comprising the step of operating said seating system to cause application to the human occupant of said physically simulated g-forces in the form of respective non-g forces;
comprising providing real-time feedback data of said predetermined physiological parameters of the human occupant at said physically simulated flight conditions; or
comprising the step wherein the human occupant initiates anti-g straining maneuvers (AGSM) for managing levels of said predetermined physiological parameters responsive to application of said non-g forces to the human occupant.

63. The method according to claim 61, comprising the step wherein the human occupant initiates anti-g straining maneuvers (AGSM) for managing levels of said predetermined physiological parameters responsive to application of said non-g forces to the human occupant, and further comprising the following steps:
a. setting said real flight conditions to correspond to a minimum g-force greater than 1 g;
b. providing real-time feedback data of predetermined physiological parameters of the human occupant at the real flight conditions of step (a);
c. the human occupant initiates anti-g straining maneuvers (AGSM) for managing levels of said predetermined physiological parameters responsive to application of said non-g forces to the human occupant corresponding to said g-force;
d. providing real-time feedback data of predetermined physiological parameters of the human occupant at the flight conditions of step (c);
e. setting said real flight conditions to correspond to an increment in said g-force;
f. repeating steps (c) and (d) at the increased g-force of step (e);
g. checking whether the increased g-force of step (e) exceeds predetermined safety limits, wherein:
if the increased g-force of step (e) exceeds predetermined safety limits, terminate the said flight simulation; or
if the increased g-force of step (e) does not exceed said predetermined safety limits repeating steps (e) to (g).

64. The method according to claim 63, including at least one of the following:
wherein said minimum g-force is 1.5 g;
wherein said increment in said g-force is 0.5 g;
wherein said predetermined safety limits corresponds to a g-force of 9 g or to a g-force of 35 g;
wherein said step of initiating said AGSM comprises the human occupant applying muscle tension procedures to predetermined muscle groups;
wherein said step of initiating said AGSM comprises the human occupant applying muscle tension procedures to predetermined muscle groups, and, wherein said predetermined muscle groups include muscles in the abdomen and extremities of the human occupant;
wherein said step of initiating said AGSM comprises the human occupant applying rapid static contractions of muscles in the arms, legs and abdomen; or
wherein said step of initiating said AGSM comprises the human occupant applying specialized breathing cycle configured to maintain air pressure in the lungs.

65. The method according to claim 61, including at least one of the following:
wherein said sensor arrangement operates to provide an electromyography (EMG) parameter of the human occupant;
wherein said sensor arrangement operates to provide a pneumograph parameter of the human occupant;
wherein said sensor arrangement operates to provide a brain blood oxygenation level parameter of the human occupant; or
wherein said real flight conditions include any one of: evasive maneuvers, dog fight maneuvers, diving maneuvers.
